(19) United States
(12) Patent Application Publication
(10) Pub. No.: US 2025/0258629 A1
(43) Pub. Date: Aug. 14, 2025

(54) NON-TRANSITORY COMPUTER-READABLE STORAGE MEDIUM STORING PROGRAM, AND METHOD

(71) Applicant: CANON KABUSHIKI KAISHA, Tokyo (JP)

(72) Inventor: HIROKI HACHIYA, Kanagawa (JP)

(21) Appl. No.: 19/046,414

(22) Filed: Feb. 5, 2025

(30) Foreign Application Priority Data
Feb. 9, 2024 (JP) 2024-018843

(51) Int. Cl. G06F 3/12

(52) U.S. Cl. CPC G06F 3/1208; G06F 3/1256

(57) ABSTRACT

A non-transitory computer-readable storage medium storing a program configured to cause a computer of an information processing apparatus to function as: a change unit configured to, in accordance with a signal that is based on a user operation on a colorimeter, change a measurement mode related to color measurement performed by the colorimeter in color verification; and a notification unit configured to provide a notification indicating the change in the measurement mode made by the change unit.

### BACKGROUND OF THE INVENTION

### Field of the Invention

The present invention relates to a non-transitory computer-readable storage medium storing a program, and a method.

### Description of the Related Art

In the field of commercial printing, the importance of and demands for a color verification process, which periodically verifies the color quality of an image forming apparatus, are increasing in recent years. In response to such demands, a system that executes a color verification process using a web browser has been disclosed. A color verification process that realizes a color verification system includes three steps: (1) printing of a color chart composed of a plurality of color patches; (2) color measurement of the color chart; and (3) color verification, in which a pass-fail inspection is performed by comparing the colorimetric result with a color criterion of the printing industry or a color criterion that has been uniquely set by a printing company.

Also, in a case where a user manually moves a colorimeter in (2), which is the step of color measurement of the color chart, the speed of movement of the colorimeter and the position thereof are critical, and the measurement could possibly fail. For this reason, a color verification system has a function of performing remeasurement. A technique has been disclosed that enables remeasurement by pressing a remeasurement button on a graphical user interface (GUI) of a color verification system via a mouse operation, and changing a measurement mode (Japanese Patent Laid-Open No. 2023-68990).

### SUMMARY OF THE INVENTION

The present invention provides a technique to improve convenience for a case where color verification is performed.

The present invention in one aspect provides a non-transitory computer-readable storage medium storing a program configured to cause a computer of an information processing apparatus to function as: a change unit configured to, in accordance with a signal that is based on a user operation on a colorimeter, change a measurement mode related to color measurement performed by the colorimeter in color verification; and a notification unit configured to provide a notification indicating the change in the measurement mode made by the change unit.

The present invention can provide a technique to improve convenience for a case where color verification is performed.

Further features of the present invention will become apparent from the following description of exemplary embodiments with reference to the attached drawings.

### BRIEF DESCRIPTION OF THE DRAWINGS

FIG. 1 is a diagram for describing a configuration of a system.

FIG. 2 is a diagram showing a configuration of an information processing apparatus.

FIG. 3 is a diagram showing a configuration of an application.

FIG. 4 is a diagram showing a color chart.

FIG. 5 is a diagram showing a GUI displayed by the application.

FIG. 6 is a sequence diagram for describing a color verification process.

FIG. 7 is a flowchart showing processing executed by the application.

FIG. 8 is a diagram showing a color chart.

FIG. 9 is a diagram showing a GUI displayed by the application.

FIG. 10 is a flowchart showing processing executed by the application.

FIG. 11 is a flowchart showing processing executed by the application.

FIG. 12 is a diagram showing an external view of a colorimeter.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

According to the conventional technique, in order to change a measurement mode of a colorimeter in the step of color measurement of a color chart, a user needs to perform an operation for changing the measurement mode by disengaging their hand from the colorimeter and then holding a mouse during a color measurement task using the colorimeter. In view of this, there have been demands for measures to improve convenience for a case where color verification is performed.

The present disclosure provides a technique to improve convenience for a case where color verification is performed.

### First Embodiment

The present embodiment provides a description of a color verification system that verifies the color quality of a printed material generated by an image forming apparatus by causing a color measurement apparatus to measure the colors of a chart on which a plurality of verification patches have been printed, and comparing the colorimetric result with an industry standard or a criterion unique to a company. In the present embodiment, this verification is referred to as “color verification”.

### <System Configuration>

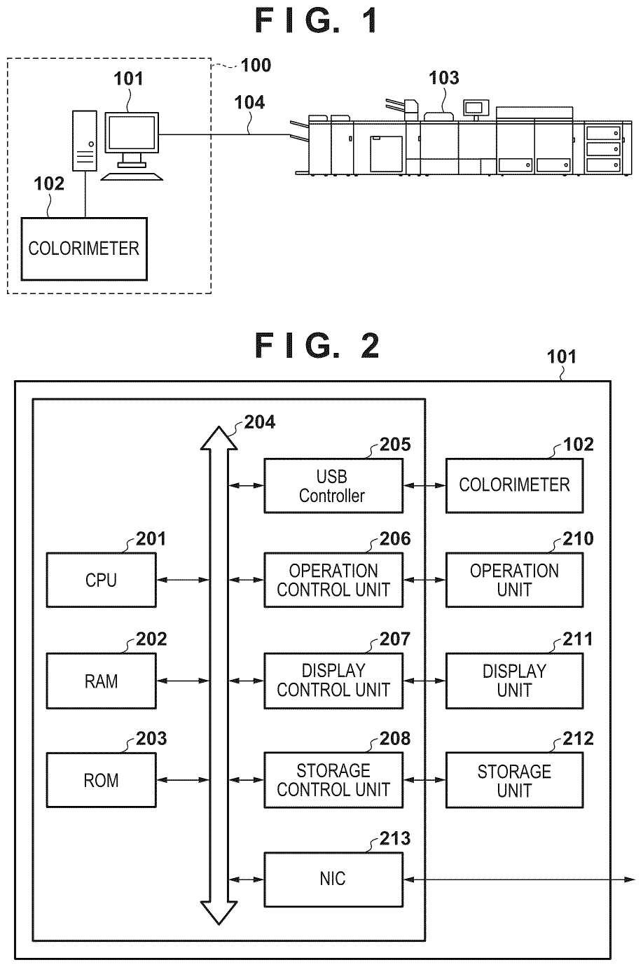

FIG. 1 is a block diagram for describing an example of a configuration of a color verification system 100 according to the present embodiment. The color verification system 100 is a system related to color verification, and includes an information processing apparatus 101 and a colorimeter 102. The color verification system 100 may include, for example, an image forming apparatus 103. Note that the apparatuses shown in FIG. 1 may be wirelessly connected to one another via a network, such as a local area network (LAN) and a wide area network (WAN). Also, the apparatuses may be connected to one another by wire via a wired LAN cable, a USB cable, or the like. Communication in processing related to color measurement, which will be described later, may be performed while the apparatuses are connected wirelessly or by wire in the foregoing manner.

Although the information processing apparatus 101 will be described using a PC as one example, no limitation is intended by this. The information processing apparatus 101 may be, for example, a mobile terminal apparatus, such as a smartphone and a tablet. As will be described later, an application that can operate on the information processing apparatus 101 is installed on the information processing apparatus 101. The application is, for example, an application program related to color verification.

The colorimeter 102 is a manual, portable colorimeter that meters and digitalizes the colors of a printed material and the like. That is to say, the colorimeter 102 can also be said to be a measurement apparatus that is, for example, capable of measuring a plurality of colors formed on a printed material and the like. Note that in the following description, metering (measuring) of colors by the colorimeter 102 may be referred to as color measurement. Also, for example, the colorimeter 102 is connected to the information processing apparatus 101 by wire via a USB cable. Furthermore, the information processing apparatus 101 and the image forming apparatus 103 are mutually connected via a network 104.

The image forming apparatus 103 is controlled under a group of programs that operate on the information processing apparatus 101, processes print settings and print data received from the information processing apparatus 101, and generates a printed material. That is to say, in other words, the image forming apparatus 103 is a print apparatus.

### <Colorimeter>

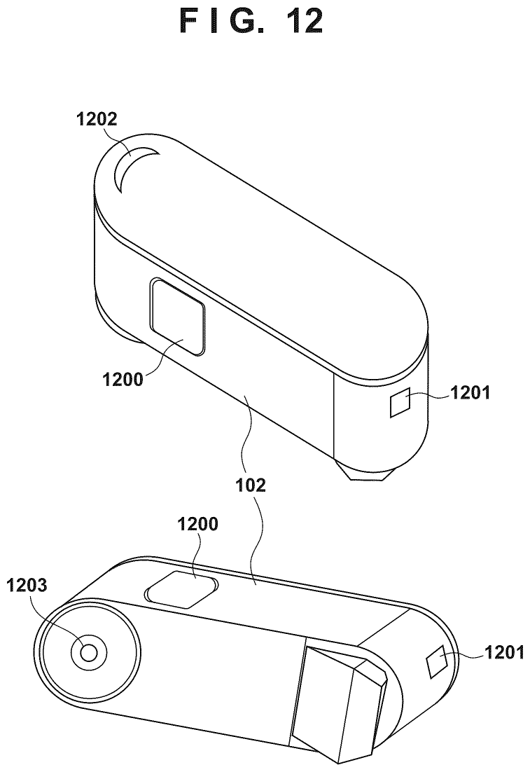

A description is now given of the colorimeter 102 according to the present embodiment with reference to FIG. 12. FIG. 12 is a diagram showing an example of an external appearance of the colorimeter 102 according to the present embodiment. Also, FIG. 12 corresponds to a perspective diagram as viewed from the flat surface side and the bottom surface side of the colorimeter 102.

As shown in FIG. 12, the colorimeter 102 has a colorimeter button 1200, a USB cable connection port 1201, and the like on the side surface of the colorimeter 102. Also, the colorimeter 102 has a light emitting unit 1202 and an opening 1203 on the top surface and the bottom surface of the colorimeter 102, respectively.

The colorimeter button 1200 is, for example, a button used during color measurement of a color chart. Specifically, for example, the colorimeter button 1200 in the present embodiment is an interface capable of accepting an instruction for execution of color measurement. The colorimeter 102 executes color measurement while a user is depressing the colorimeter button 1200, for example.

The light emitting unit 1202 is an indicator for conveying a device state by emitting light in white, green, red, or the like. Also, the light emitting unit 1202 is not limited to emitting light in the above-mentioned colors, and may be an indicator that emits light in another color, such as blue and yellow.

The opening 1203 is an opening for measuring colors with use of, for example, a color measurement unit (not shown) that measures colors.

The following describes an example of a method of color measurement of a color chart using the colorimeter 102. For example, a user places the opening 1203 of the colorimeter 102 at a margin portion or the like of a color chart. Thereafter, while the user keeps depressing the colorimeter button 1200, the user slides the colorimeter 102 in one direction along a predetermined row of patches for color verification printed on the color chart. Also, when the colorimeter 102 has finished passing through every color patch in one row, the user disengages their finger from the colorimeter button 1200 that has been depressed. The user repeatedly performs this operation for each row of patches for color verification.

Furthermore, for example, when the user has finished depressing the colorimeter button 1200, the colorimeter 102 transmits a colorimetric value to an application related to color verification. Here, the colorimetric value transmitted by the colorimeter 102 is, for example, a CMYK signal value. Furthermore, in the following description, the colorimetric value transmitted by the colorimeter 102 may be referred to as a colorimetric result.

Note that the colorimeter 102 is not limited to having the above-described configuration, and where appropriate, has a hardware configuration corresponding to the functions that can be executed by a device applied as the colorimeter 102. The colorimeter 102 may include, for example, a display unit, such as a touch panel and a display.

### <Information Processing Apparatus>

FIG. 2 is a diagram showing an example of a hardware configuration of the information processing apparatus 101 according to the present embodiment.

The information processing apparatus 101 includes, for example, a CPU 201, a RAM 202, a ROM 203, a bus 204, a USB controller 205, an operation control unit 206, a display control unit 207, a storage control unit 208, an operation unit 210, a display unit 211, a storage unit 212, an NIC 213, and the like.

The CPU 201 is a system control unit, and controls the entirety of the information processing apparatus 101. The CPU 201 executes each type of processing by reading out a program like an OS and an application stored in a storage medium, such as the ROM 203 and the storage unit 212, into the RAM 202 that acts as a working area, and executing the program.

The RAM 202 is, for example, a volatile storage, and is used as a main memory, a working memory, and the like when executing various types of programs stored in the storage unit 212. The ROM 203 is, for example, a nonvolatile storage, and stores programs executed by the CPU 201 and fixed data, such as an embedded operating system (hereinafter referred to as OS) program.

The USB controller 205 controls, for example, communication with the colorimeter 102. The USB controller 205 is used in, for example, transmission of instructions from the information processing apparatus 101 to the colorimeter 102, reception of the result of measurement performed by the colorimeter 102, and reception of operation signals of the colorimeter 102 and the like.

The operation control unit 206 is connected to the operation unit 210. The operation control unit 206 obtains information related to a user operation that has been accepted via the operation unit 210, and transmits this information to the CPU 201. The operation unit 210 may be, for example, a pointing device like a mouse, a keyboard, or the like.

The display control unit 207 is connected to the display unit 211. The display control unit 207 controls display on the display unit 211. The display unit 211 may be, for example, a display device like a liquid crystal display and an organic EL display. Also, the display unit 211 may be, for example, a touch panel or the like capable of accepting user operations.

The storage control unit 208 executes control intended to cause the storage unit 212 to store programs and data for making the information processing apparatus 101 operate, and to read out the same from the storage unit 212. The storage unit 212 stores a boot program, various types of application, font data, other various types of data, and so forth. The storage unit 212 is, for example, a storage apparatus, such as a hard disk drive (HDD) and a solid state drive (SSD). Also, the storage unit 212 may include a large-capacity storage apparatus that replaces the HDD and SSD.

The network controller (NIC) 213 is connected to a network, and executes processing for controlling communication with other devices connected to this network. Furthermore, the internal configuration of the network controller 213 varies between a case where apparatuses included therein have a wired LAN or a wireless LAN and a case where they have both. Note that the network controller (NIC) 213 is configured so that such differences in the internal configuration are hidden thereinside, and the system can be controlled under the assumption that the internal configuration is the same to other modules shown in the figure.

The bus 204 connects the CPU 201, the RAM 202, the ROM 203, various types of controllers, and the like, and carries data signals and control signals.

Note that the information processing apparatus 101 is not limited to having the above-described configuration, and where appropriate, has a hardware configuration corresponding to the functions that can be executed by a device applied as the information processing apparatus 101.

### <Color Verification Process>

The above-described color verification system 100 performs a color verification process for periodically verifying the color quality of the image forming apparatus 103. The color verification process includes, for example, three steps: (1) printing of a color chart composed of a plurality of color patches; (2) color measurement of the color chart; and (3) color verification, in which a pass-fail inspection is performed by comparing the colorimetric result with a color criterion of the printing industry or a color criterion that has been uniquely set by a printing company.

Meanwhile, in a case where a user manually moves the colorimeter 102 in (2), which is the step of color measurement of the color chart, the speed of movement of the colorimeter 102 and the position thereof are critical, and the color measurement could possibly fail. For this reason, the color verification system has, for example, a function of performing remeasurement of colors. For example, the user changes a measurement mode by pressing, via a mouse operation or the like, a remeasurement button on a graphical user interface (hereinafter, GUI) displayed on the display unit 211 of the information processing apparatus 101 or the like by an application related to color verification.

In this way, in order to change the measurement mode of the colorimeter 102 in the step of color measurement of the color chart, the user needs to perform an operation for changing the measurement mode by disengaging their hand from the colorimeter and then holding a mouse or the like of the information processing apparatus 101 during a color measurement task using the colorimeter 102. In view of this, there have been demands for measures to improve convenience for a case where color verification is performed.

In the present embodiment, an application program 300 (hereinafter referred to as an application 300) related to color verification changes a measurement mode related to measurement performed by the colorimeter 102 in color verification in accordance with a signal that is based on a user operation on the colorimeter 102. Then, the application 300 gives notice of the change in the measurement mode.

The foregoing aspect allows the user to, when they want to change the measurement mode during color measurement, change the measurement mode without switching from an operation on the colorimeter 102 to an operation on the information processing apparatus 101. Also, for example, even in a case where the location where the user is performing color measurement of the color chart using the colorimeter 102 is distanced from the location of the information processing apparatus 101, the user does not need to move to change the measurement mode. This can improve convenience for a case where color measurement is performed.

### <Application>

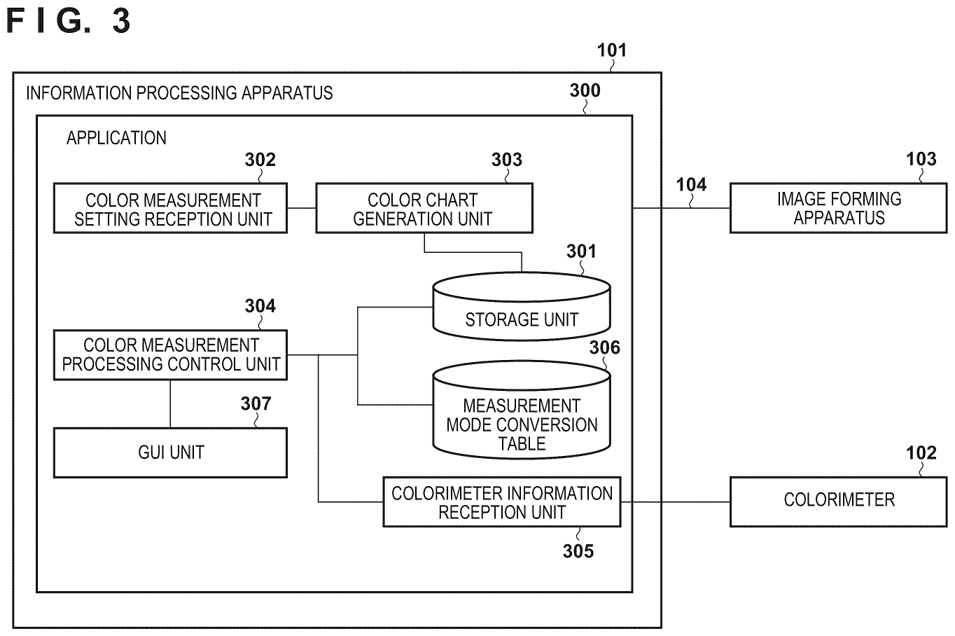

The following describes the application 300 with reference to FIG. 3. FIG. 3 is a block diagram showing an example of a configuration of the application 300 according to the present embodiment. The application 300 is installed on, for example, the information processing apparatus 101, and stored in a memory, such as the ROM 203 and the storage unit 212. Also, the application 300 (hereinafter, application 300) will be described as a color verification application program that executes the color verification process.

The application 300 includes a storage unit 301, a color measurement setting reception unit 302, a color chart generation unit 303, a color measurement processing control unit 304, a colorimeter information reception unit 305, a measurement mode conversion table 306, a GUI unit 307, and the like. The functions of respective program modules are realized by, for example, the CPU 201 executing each program module.

The storage unit 301 stores each type of information related to the color verification process. Specifically, the storage unit 301 stores, for example, information of a signal value for generating the color chart, name information of color standards, sheet information, information of an image forming apparatus currently connected, and so forth. Also, the storage unit 301 stores information obtained by combining these pieces of information. Furthermore, the storage unit 301 stores, for example, a colorimetric value of the color chart whose colors have been measurement by the colorimeter 102.

The color measurement setting reception unit 302 receives information of color measurement settings that have been input by the user from a graphical user interface (hereinafter, GUI) (not shown) displayed by the application 300. The information of color measurement settings is, for example, content related to various types of settings for generating the color chart. The information of color measurement settings is, for example, information of the types of color standards, information of a sheet to be used, information of an image forming apparatus currently connected, and so forth. Also, the information of color measurement settings is not limited to the foregoing, and may include other types of information. The other types of information may be, for example, information of lighting conditions and the like. The application 300 stores the information of color measurement settings received by the color measurement setting reception unit 302 into the storage unit 301.

Based on the information of color measurement settings received by the color measurement setting reception unit 302, the color chart generation unit 303 refers to various types of information stored in the storage unit 301 and generates a color chart. In the present embodiment, the color chart generation unit 303 generates data of a color chart 400 that includes color verification patches 402 and measurement mode change patches 401. The color verification patches 402 are, for example, color patches corresponding to a color standard (color sample) that conforms with color specifications of a printing company, the industry, or the like. The measurement mode change patches 401 are, for example, color patches for changing a measurement mode related to color verification. The details of these patches 401 and 402 will be described later.

Also, for example, when generating the color chart 400, the color chart generation unit 303 refers to the later-described measurement mode conversion table 306, and generates the measurement mode change patches 401 corresponding to the color verification patches 402. The measurement mode change patches 401 corresponding to the color verification patches 402 are the measurement mode change patches 401 that have different colors from the color verification patches 402 included in the color chart 400, as will be described later. Furthermore, the color chart generation unit 303 generates data of the color chart 400 by arranging the measurement mode change patches 401 in a margin of the color chart 400. That is to say, the color chart generation unit 303 generates data of the color chart 400 in which each of the patches 401 and 402 is arranged so that the color verification patches 402 and the measurement mode change patches 401 do not overlap one another on the color chart 400.

The color measurement processing control unit 304 processes the colorimetric value (measurement result) that the colorimeter information reception unit 305 has received from the colorimeter 102.

The measurement mode conversion table 306 is a table for determining whether the colorimetric value (colorimetric result) that the colorimeter information reception unit 305 has received from the colorimeter 102 is a signal value for changing the measurement mode.

Now, reference is made to table 1. Table 1 represents an example of the measurement mode conversion table 306 according to the present embodiment (hereinafter referred to as a measurement mode conversion table 3061 in the present embodiment).

TABLE 1

| | Patch Signal | Patch Signal | |
|---|---|---|---|
| Color | Value (1) | Value (2) | Measurement |
| Chart ID | (C, M, Y, K) | (C, M, Y, K) | Mode |
| ID 1111 | 100, 90, 0, 0 | 0, 0, 100, 0 | Remeasurement |
| ID 2222 | 0, 100, 30, 0 | 100, 0, 50, 0 | Remeasurement |
| . . . | . . . | . . . | . . . |

As shown in table 1, the measurement mode conversion table 3061 includes a color chart ID, a patch signal value (1), a patch signal value (2), and a measurement mode as items.

A plurality of color charts exist respectively for the color standards; thus, color chart IDs are IDs for managing the plurality of color charts. Specifically, for example, the color verification patches 402 exist for each color standard. Also, as described above, the color chart generation unit 303 generates the measurement mode change patches 401 corresponding to the color verification patches 402. Therefore, a color chart ID is an identifier that is intended to manage, for each set of color verification patches 402, color information (CMYK signal value) of the measurement mode change patches 401 in association with a measurement mode corresponding to that color information.

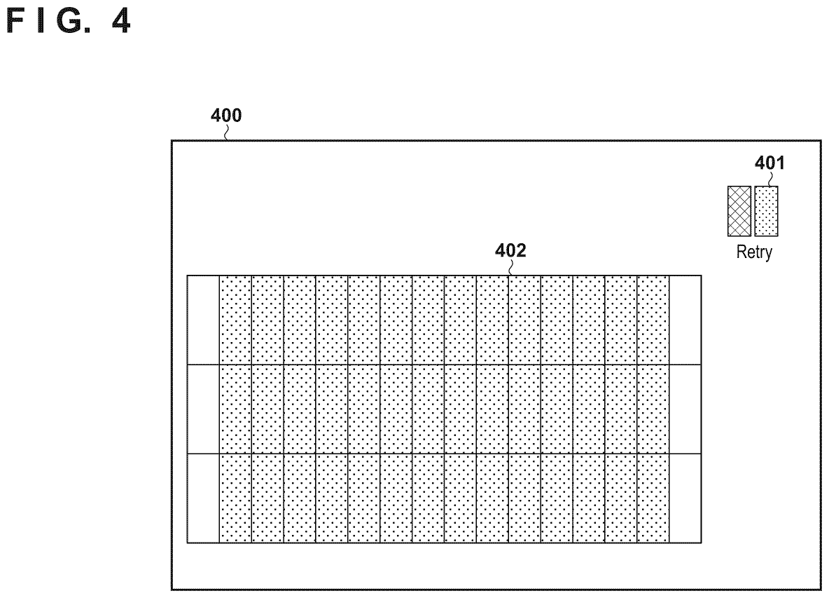

The patch signal value (1) and the patch signal value (2) are, for example, color information (CMYK signal values) corresponding to the measurement mode change patches 402. The present embodiment will be described using an exemplary case where the measurement mode change patches 401 are formed of two colors as shown in FIG. 4, which will be described later. Therefore, the measurement mode conversion table 3061 has two items: the patch signal value (1), and the patch signal value (2). In a case where the application 300 has received the colorimetric result of the measurement mode change patches 401 from the colorimeter 102, it cross-references the bicolor signal values acting as the colorimetric result with the patch signal value (1) and the patch signal value (2) in the measurement mode conversion table 3061, and determines a measurement mode to which it should switch.

Note that the patch signal value is not limited to being listed under two items, but may be listed under two or more items. Using a plurality of patch signal values in this way makes it possible to prevent the measurement mode from being changed erroneously. Note that as the measurement mode change patches 401 and the color verification patches 402 are formed of different colors from one another, there may be one patch signal value.

Furthermore, a patch signal value in the measurement mode conversion table 3061 may be given a range of positive or negative allowable values. As one example, provided that a patch signal value in the measurement mode conversion table 3061 is (0, 0, 100, 0) and each CMYK value is given a permissible range of ±5, the application 300 executes processing while permitting the value of (0-5, 0-5, 95-100, 0-5). In this way, even in a case where there is a deviation between each patch signal value in the measurement mode conversion table 3061 and a colorimetric value of an actual printed material, the measurement mode can be changed if the colorimetric value is within the permissible range. The colorimetric value in the permissible range can also be said to be a permissible colorimetric error. Note that the permissible range is not limited to the above-described value, and may be, for example, set with a value larger than ±5 or set with a value smaller than ±5 for each CMYK value.

In the present embodiment, a remeasurement mode for performing remeasurement with respect to one row of color verification patches that have been measured once is stored under the measurement mode in the measurement mode conversion table 3061. The remeasurement mode is, for example, an operation mode in which, each time the colorimetric value of one row of color verification color patches has been received from the colorimeter 102, the colorimetric value of one row for which color verification has already been performed is overwritten. For example, as will be described later, in a case where the application 300 has received the colorimetric result of the color verification patches 402 from the colorimeter 102, it determines whether there is a deviation between this colorimetric result and a predetermined target value (criterion value). That is to say, the application 300 performs color verification for verifying whether the color verification patches 402 on the printed color chart 400 have a value that satisfies a predetermined criterion. As described above, color measurement performed by the colorimeter 102 could possibly fail depending on, for example, the speed at which the user moves the colorimeter 102 or the position of color measurement. In this case, the user can perform remeasurement by reading the measurement mode change patches 402 using the colorimeter 102 and changing the measurement mode used in color verification to the remeasurement mode. Specifically, for example, in a case where the application 300 has received the colorimetric values of the measurement mode change patches 402 from the colorimeter 102, it refers to the measurement mode conversion table 3061, and changes the measurement mode to the remeasurement mode. Then, for example, when the application 300 has received the colorimetric value of the color verification patches 402 from the colorimeter 102 again, it operates so as to perform color verification again using this colorimetric value. That is to say, the remeasurement mode can also be said to be a mode that performs color verification with respect to a remeasured color value received from the colorimeter 102. Also, the remeasurement mode can also be said to be a reverification mode.

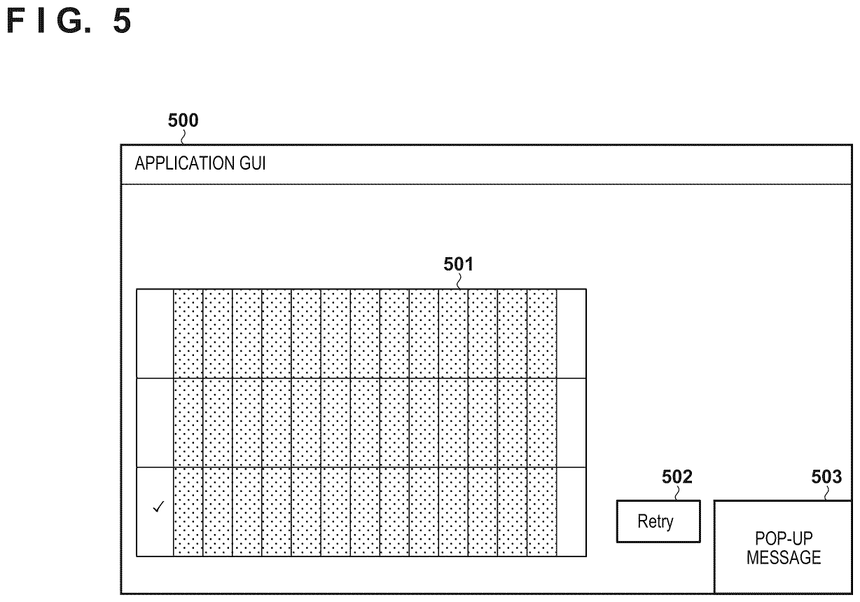

The GUI unit 307 controls a GUI of the application 300 shown in FIG. 5, which will be described later.

### <Color Chart>

Next, the color chart according to the present embodiment will be described with reference to FIG. 4. FIG. 4 is a diagram showing an example of a color chart 400 according to the present embodiment. For example, the application 300 instructs the image forming apparatus 103 to perform printing that is based on data of the color chart 400 generated by the color chart generation unit 303. Then, based on the data of the color chart 400, the image forming apparatus 103 executes printing; as a result, the color chart 400 is output.

The color chart 400 includes the measurement mode change patches 401 and the color verification patches 402. The following describes these patches 401 and 402.

The measurement mode change patches 401 are patches for changing the measurement mode of the application 300. Also, in the present embodiment, the measurement mode change patches 401 include two color patches. That is to say, the measurement mode change patches 401 are formed of two colors. For example, in a case where the application 300 has received the colorimetric values of the measurement mode change patches 401 as a colorimetric result from the colorimeter 102, it changes the measurement mode to the remeasurement mode. In this way, the color chart 400 includes the measurement mode change patches 401 separately from the color verification patches 402. As a result, when the user wants to change the measurement mode, they can change the measurement mode by reading the measurement mode change patches 401 using the colorimeter 102 without performing an operation on the information processing apparatus 101. That is to say, convenience can be improved for the user in color verification.

Also, in the present embodiment, each color patch in the measurement mode change patches 401 has a different color from the color verification patches 402. That is to say, the color patches in the measurement mode change patches 401 are a combination of colors that do not exist in the color verification patches 402. For example, the color chart generation unit 303 generates patches representing a combination of two colors that do not exist in the color verification patches 402. Specifically, for example, when generating the color chart 400, the color chart generation unit 303 determines the colors to be used in the color verification patches 402 with reference to the storage unit 301. Then, the color chart generation unit 303 generates the measurement mode change patches 401 using the colors that are not used in the color verification patches 402. This can prevent the measurement mode from being changed as a result of performing color measurement of the color verification patches 402.

Note that the color patches in the measurement mode change patches 401 may have the same color, or may have different colors. Also, although the measurement mode change patches 401 are composed of two color patches in the present example, no limitation is intended by this. The measurement mode change patches 401 may be, for example, composed of one color patch, or composed of two or more color patches.

Furthermore, information corresponding to the measurement mode change patches 401 is displayed around the measurement mode change patches 401. The information corresponding to the measurement mode change patches 401 is a word indicating the measurement mode to switch to, and is also a word indicating the function of the measurement mode change patches. The present embodiment presents an example in which a character string Retry is presented as a word indicating a change to the remeasurement mode.

The color verification patches 402 are patches for color verification corresponding to a color standard (color sample). That is to say, the color verification patches 402 are patches that function as a color chart. The color verification patches 402 are composed of a plurality of color patches in accordance with, for example, a color standard selected by the user. Also, the plurality of color patches are arranged in predetermined rows and columns. Furthermore, at both ends of each row of the color verification patches 402, for example, a frame of a color measurement start position is provided. This frame of the color measurement start position is white in color, for example. For example, the user places the colorimeter 102 on this frame, and slides the colorimeter 102 to the left or right, thereby measuring the color verification patches 402 on a row-by-row basis.

Note that in the present embodiment, as stated earlier, the color verification patches 402 are generated in accordance with a color standard; no limitation is intended by the number and the arrangement (rows and columns) of the color patches that compose the color verification patches 402 shown in the figures, and they may be changed as appropriate. Also, although the present embodiment has been described using an example in which the color patches in the measurement mode change patches 401 are arrayed in the horizontal direction, they may be arrayed in the vertical direction. Furthermore, although the present embodiment has been described using an example in which the frame of the measurement start position is provided at both ends of each row of the color verification patches 402, it may be provided at both ends of each column of the color verification patches 402. Then, color measurement may be performed for each column of the color verification patches 402.

### <Application GUI>

FIG. 5 is a diagram showing an example of an application GUI that is displayed on the display unit 211 of the information processing apparatus 101 by the application 300 according to the present embodiment. The application GUI is a screen related to color verification.

The application GUI 500 includes, for example, a color chart colorimetry status 501, a remeasurement button 502, a message display unit 503, and the like.

The color chart colorimetry status 501 shows a chart with a color scheme similar to that of the color verification patches 402. Also, the color chart colorimetry status 501 shows information indicating a progress status of color measurement of the color chart 400 performed by the colorimeter 102. The information indicating the progress status may be displayed by, for example, displaying, with emphasis, a row of color verification patches 402 for which color measurement has been performed by the colorimeter 102. Furthermore, an icon, a mark, or the like indicating that color measurement has already been performed may also be displayed as the information indicating the progress status. In FIG. 5, as one example, the color chart colorimetry status 501 shows a mark indicating that color measurement has been completed for the bottom row of color verification patches 402 in the color chart. This allows the user to recognize the status of color measurement for each row of color verification patches 402.

The remeasurement button 502 is a button capable of accepting an instruction for changing the measurement mode. For example, when the user has pressed the remeasurement button 502, the application 300 changes the measurement mode to the remeasurement mode.

The message display unit 503 displays, as a pop-up, a message that is in coordination with an operation of the application 300. In the present embodiment, the message display unit 503 displays, for example, a warning message, a message about a change in the measurement mode, and the like.

The warning message is, for example, a message that suggests remeasurement of colors. The warning message is displayed on the message display unit 503 in a case where, for example, the application 300 has determined that there is a deviation equal to or larger than a threshold between a colorimetric value of the color verification patches 402 received from the colorimeter 102 and a preset target value. Note that the warning message may include a message indicating that there is a deviation between the colorimetric value of the color verification patches 402 and the target value.

The message about the change in the measurement mode is a message indicating that the measurement mode has been changed. The message about the change in the measurement mode is displayed on the message display unit 503 in a case where, for example, the application 300 has changed the measurement mode.

### <Processing in Color Verification System>

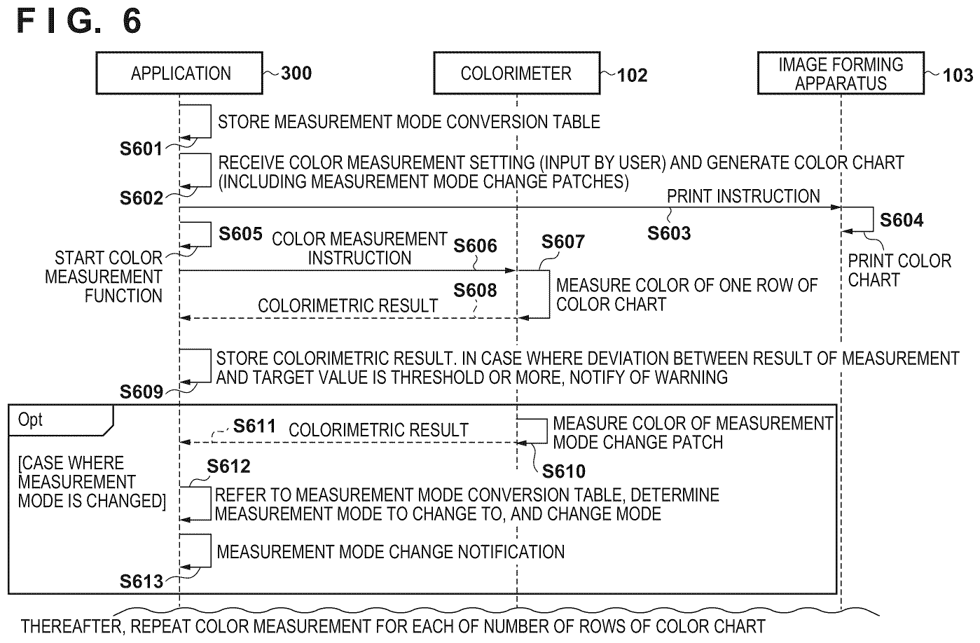

FIG. 6 is a sequence diagram for describing the color verification system according to the present embodiment. Processing that is executed by each apparatus in the present sequence is realized when various types of programs stored in a memory included in each apparatus, such as a ROM, are read out to a RAM and executed by a CPU included in each apparatus. Note that the present sequence may be started based on, for example, acceptance of an instruction for starting the execution of color verification on the application 300. For example, a screen (not shown) display by the application 300 may be provided with an interface (not shown) capable of accepting the instruction for starting the execution of color verification.

In step S601, the application 300 reads out the measurement mode conversion table 306, and stores the same into the storage unit 301.

In step S602, the application 300 receives information of color measurement settings, and generates data of the color chart 400 corresponding to the received information of color measurement settings. The information of color measurement settings is input via, for example, a user's GUI operation. That is to say, the application 300 accepts the input of the information of color measurement settings, and generates the data of the color chart 400 on the basis of the received color measurement settings.

In step S603, the application 300 instructs the image forming apparatus 103 to execute printing of the data of the color chart 400 generated in step S601. Specifically, for example, the application 300 transmits the data of the color chart 400 and a print instruction for the color chart 400 to the image forming apparatus 103.

In step S604, based on the reception of the print instruction from the application 300, the image forming apparatus 103 executes printing that is based on the data of the color chart 400.

In step S605, based on the reception of an instruction for starting the color measurement function, the application 300 starts the color measurement function. Specifically, for example, based on the reception of the instruction for starting the color measurement function, the application 300 is placed in a state where it can issue a color measurement instruction to the colorimeter 102. For example, the application 300 accepts the instruction for starting the color measurement function via a user's GUI operation (not shown).

Note, for example, the application 300 may start the color measurement function in a normal measurement mode as a default mode at the time of the start of the color measurement function. That is to say, the normal measurement mode may be set as an initial setting of the color measurement function of the application 300. The normal measurement mode may be, for example, a mode for obtaining a colorimetric value corresponding to a single session. For example, in a case where the application 300 is operating in the normal measurement mode, if the application 300 receives a colorimetric value of the color verification patches 402 from the colorimeter 102, the later-described color verification may be performed using the colorimetric value corresponding to a single session.

In step S606, the application 300 transmits a color measurement instruction to the colorimeter 102. The color measurement instruction is, for example, an instruction for switching the colorimeter 102 from a standby state to a state for performing color measurement. That is to say, the color measurement instruction is also an instruction for activating the colorimeter 102. Furthermore, the color measurement instruction may also be, for example, an instruction for executing calibration with respect to the colorimeter 102.

In step S607, based on a user operation, the colorimeter 102 performs color measurement of the color chart 400. Specifically, the colorimeter 102 performs color measurement of one row of color verification patches 402 on the color chart 400.

In step S608, the colorimeter 102 transmits, to the application 300, the colorimetric result (colorimetric value) of the color chart 400 for which color measurement has been performed in step S607. The colorimetric result is, for example, a CMYK signal value.

In step S609, the application 300 receives the colorimetric result from the colorimeter 102. Also, the application 300 stores the colorimetric result received from the colorimeter 102 into the storage unit 301. Furthermore, in a case where there is a deviation equal to or larger than a threshold between the colorimetric value and a target value (criterion value), the application 300 notifies the user of a warning. For example, the application 300 displays a warning message on message display unit 503. Note that the application 300 may give notice of the warning message in the form of a sound with use of a speaker or the like (not shown) of the information processing apparatus 101.

The following describes processing that is executed by the application 300 and the colorimeter 102 in a case where the measurement mode is changed. The case where the measurement mode is changed is, for example, a case where the measurement mode is changed by the user who has recognized the warning message of which they have been notified by the application 300 in step S608.

In step S610, based on a user operation, the colorimeter 102 performs color measurement of the measurement mode change patches 401.

In step S611, the colorimeter 102 transmits, to the application 300, a colorimetric value of the measurement mode change patches 401 for which color measurement has been performed in step S609.

In step S612, the application 300 receives the colorimetric value transmitted from the colorimeter 102 in step S611. The application 300 refers to the measurement mode conversion table 306, and determines a measurement mode corresponding to the received colorimetric value. Then, the application 300 changes the measurement mode.

In step S613, the application 300 provides a notification indicating the change in the measurement mode. Specifically, for example, the application 300 displays a message indicating that the measurement mode has been changed on the message display unit 503, or displays the remeasurement button 502 with emphasis. The display with emphasis may be, for example, changing of the color of the remeasurement button 502 and the like. Furthermore, the notification indicating that the measurement mode has been changed is not limited to the aforementioned message or display of the button with emphasis, and may be, for example, provided in the form of a sound or the like with use of a speaker (not shown) or the like of the information processing apparatus 101. By being notified of the change in the measurement mode in the foregoing manner, the user can recognize that the measurement mode has been changed.

Thereafter, in processing shown in FIG. 6, processing of steps S607 to S609 and processing of steps S610 to S613 are repeated in accordance with the number of rows of color verification patches on the color chart.

### <Processing Related to Changing of Measurement Mode>

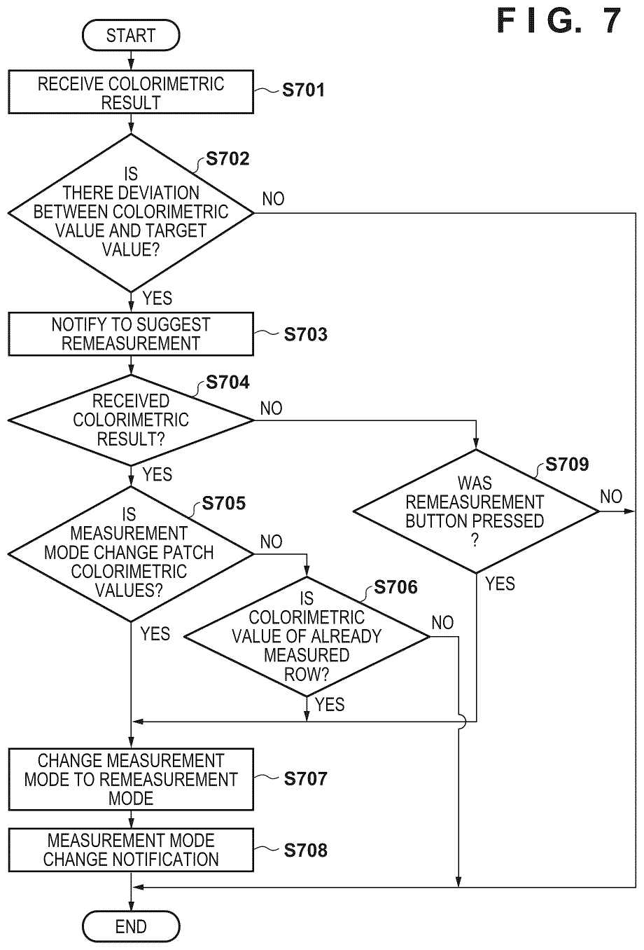

With reference to FIG. 7, a description is now given of an example of processing related to changing of the measurement mode according to the present embodiment. FIG. 7 is a flowchart showing examples of operations executed by the application 300 according to the present embodiment. Although the description will be provided under the assumption that the main executor of each type of processing in FIG. 7 is each program module in the application 300, processing executed by each program module is realized when the application 300 stored in a memory, such as the ROM 203, is deployed to the RAM 202 and executed by the CPU 201.

In step S701, the colorimeter information reception unit 305 receives a colorimetric result corresponding to one row of color verification patches 402 from the colorimeter 102. Also, in step S701, the colorimetric result received by the colorimeter information reception unit 305 is stored into the storage unit 301, for example.

In step S702, the color measurement processing control unit 304 determines whether there is a deviation equal to or larger than a threshold between the colorimetric value received in step S701 and a predetermined target value (criterion value). That is to say, the color measurement processing control unit 304 performs color verification with respect to the colorimetric result. In a case where it has been determined that there is a deviation in processing of step S702, processing proceeds to step S703. On the other hand, in a case where it has been determined that there is no deviation in processing of step S702, processing of FIG. 7 is ended.

In step S703, the GUI unit 307 provides a notification that suggests remeasurement. Specifically, the GUI unit 307 displays a message that suggests remeasurement as the pop-up message on the message display unit 503. Note that although the present embodiment has been described using an aspect in which the message that suggests remeasurement is displayed as one example, an aspect thereof may be such that the notification that suggests remeasurement is provided in the form of a sound or the like.

Processing of steps S701 to S703 is equivalent to, for example, processing that has been described in relation to step S609.

In step S704, the color measurement processing control unit 304 determines whether the colorimeter information reception unit 305 has received the colorimetric result. In a case where the color measurement processing control unit 304 has determined that the colorimetric result has been received, it proceeds to step S705. On the other hand, in a case where the color measurement processing control unit 304 has determined that the colorimetric result has not been received, it proceeds to step S709.

In step S705, the color measurement processing control unit 304 determines whether the colorimetric result that was determined to have been received in step S704 is the measurement result of the measurement mode change patches 401. In other words, in step S705, the color measurement processing control unit 304 determines whether the colorimetric result that was determined to have been received in step S704 is the colorimetric values of the measurement mode change patches 401 or the colorimetric value of the color verification patches 402. In a case where it has been determined that the colorimetric result is of the measurement mode change patches 401 in processing of step S705, processing proceeds to step S707. On the other hand, in a case where it has been determined that the colorimetric result is not of the measurement mode change patches 401 in processing of step S705, processing proceeds to step S706.

Specifically, the color measurement processing control unit 304 searches the measurement mode conversion table 3061 for a combination of CMYK signal values acting as the colorimetric result received from the colorimeter 102. Then, the color measurement processing control unit 304 determines whether the combination of the CMYK signal values received from the colorimeter 102 is included in the measurement mode conversion table 3061. In the present embodiment, as stated earlier, the measurement mode conversion table 3061 stores the patch signal values (1) and (2). Also, the measurement mode change patches 401 according to the present embodiment are composed of bicolor color patches. That is to say, in a case where the colorimetric values of the measurement mode change patches 401 have been received from the colorimeter 102, it is determined that the colorimetric result is of the measurement mode change patches 401 in step S705 because the measurement mode conversion table 3061 includes the patch signal values (1) and (2) corresponding to the bicolor color patches in the measurement mode change patches 401. On the other hand, in a case where the colorimetric value of the color verification patches 402 has been received from the colorimeter 102, it is determined that the colorimetric result is not of the measurement mode change patches 401 in step S705 because the measurement mode conversion table 3061 does not include the patch signal values (1) and (2) corresponding to the color verification patches 402.

In step S706, the color measurement processing control unit 304 determines whether the colorimetric value received in step S704 is a colorimetric value of a row that has already been measured. In a case where the color measurement processing control unit 304 has determined that the received colorimetric value is a colorimetric value of a row that has already been measured, it proceeds to step S707. On the other hand, in a case where the color measurement processing control unit 304 has determined that the received colorimetric value is not a colorimetric value of a row that has already been measured, processing of FIG. 7 is ended.

In step S706, specifically, for example, the color measurement processing control unit 304 refers to the storage unit 301, and determines whether it stores a colorimetric value that is the same as the colorimetric result received in step S704. Also, as stated earlier, in step S701, the colorimetric result received by the colorimeter information reception unit 305 is stored in the storage unit 301. For example, in step S706, in a case where the colorimetric result received in step S704 is the same as the colorimetric result stored in step S701, the color measurement processing control unit 304 determines that the received colorimetric result is a measured value of a row that has already been measured. On the other hand, in a case where the colorimetric result received in step S704 is different from the colorimetric result stored in step S701, it is determined that the received colorimetric result is not the same as a measured value of a row that has already been measured. Note that in this determination, if the colorimetric result received in step S704 and the colorimetric value stored in the storage unit 301 are within a predetermined permissible range, the received colorimetric result may be determined to be a measured value of a row that has already been measured.

Furthermore, in step S706, in a case where the same colorimetric value as a row that has already been measured has been received in step S704, it can be determined that remeasurement has been performed; thus, in this case, processing proceeds to step S707. Also, the case where the received colorimetric value is not the same as a colorimetric value of a row that has already been measured is, for example, a case where the colorimetric result of a row that has not been measured yet or a row that does not exist in the color verification patches 402 has been received and the like. In this case, as it can be determined that the measurement mode is not to be changed, processing of FIG. 7 is ended.

In step S707, the color measurement processing control unit 304 changes the measurement mode to the remeasurement mode.

In step S708, the GUI unit 307 provides a notification indicating the change in the measurement mode. Specifically, for example, the GUI unit 307 may display, as a pop-up, a message indicating that the measurement mode has been changed on the message display unit 503. Also, the GUI unit 307 may provide a notification indicating that the measurement mode has been changed by displaying the remeasurement button 502 with emphasis. The display with emphasis may be, for example, changing of the color of the remeasurement button 502. Furthermore, the notification indicating that the measurement mode has been changed may be provided in the form of a sound or the like with use of a speaker (not shown) or the like of the information processing apparatus 101.

In step S709, the color measurement processing control unit 304 determines whether the remeasurement button 502 has been pressed. In a case where the color measurement processing control unit 304 has determined that the button has been pressed in processing of step S709, it proceeds to step S707. On the other hand, in a case where the color measurement processing control unit 304 has determined that the button has not been pressed, processing of FIG. 7 is ended.

As described above, in the present embodiment, the application 300 generates data of the color chart 400 that includes the measurement mode change patches 401 and the color verification patches 402. Also, in a case where the application 300 has received the colorimetric result of the measurement mode change patches 401 as a signal that is based on a user operation on the colorimeter 102, it changes the measurement mode. In this way, for example, in a case where the user wants to change from the measurement mode to the remeasurement mode during a color measurement task for the color chart 400, the user can change to the remeasurement mode merely by operating the colorimeter 102 without performing an operation on the information processing apparatus 101. This can improve convenience for a case where color verification is performed.

### Second Embodiment

The following describes a second embodiment with a focus on the differences from the first embodiment. The first embodiment has been described using the remeasurement mode as the measurement mode as one example. The present embodiment will be described in relation to a case where a plurality of measurement modes exist.

### <Color Chart>

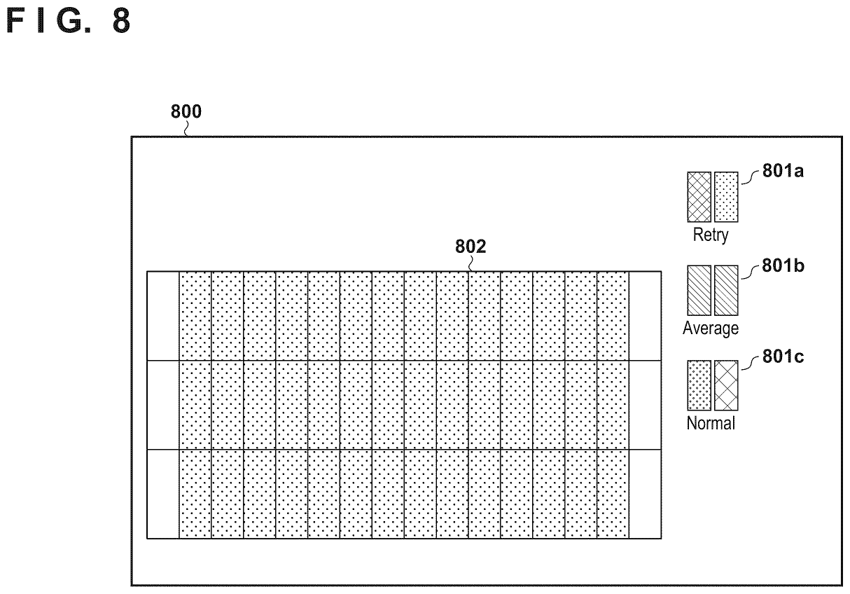

FIG. 8 shows an example of a color chart generated by the color chart generation unit 303 according to the present embodiment. A color chart 800 includes a plurality of measurement mode change patches 801a to 801c and color verification patches 802.

The measurement mode change patches 801a are patches for changing the measurement mode to a remeasurement mode.

The measurement mode change patches 801b are patches for changing the measurement mode to an average measurement mode. The average measurement mode is a mode for performing measurement with higher accuracy. The average measurement mode is, for example, a mode for obtaining an average value of colorimetric values corresponding to multiple sessions. For example, in a case where the application 300 has changed to the average measurement mode, it receives a colorimetric value multiple times from the colorimeter 102 with respect to one row of color verification patches 802. Then, the application 300 may determine whether there is a deviation between the average value of the received colorimetric values corresponding to multiple sessions and a target value (color verification). Note, for example, multiple sessions may be two sessions, or may be larger than two sessions.

The measurement mode change patches 801c are patches for changing the measurement mode to a normal measurement mode.

Note that in the present embodiment, it is assumed that the application 300 starts the color measurement function in the normal measurement mode as a default mode at the time of the start of the color measurement function. That is to say, it is assumed that the normal measurement mode is set as an initial setting of the color measurement function of the application 300.

Similarly to the first embodiment, words indicating the roles of patches are provided around the measurement mode change patches 801a to 801c. Also, the measurement mode change patches 801a to 801c include two color patches. Note that they are not limited to including two color patches, and may include one patch or more than two patches. Note that the color patches in the measurement mode change patches 801a to 801c are composed of a single color or a combination of multiple colors that do not match the colors of other color patches.

### <Measurement Mode Conversion Table>

Using Table 2, a description is now given of a measurement mode conversion table according to the present embodiment. Table 2 represents an example of a measurement mode conversion table 3062 according to the present embodiment. The measurement mode conversion table 3062 includes a normal mode and an average mode, in addition to a remeasurement mode, as measurement modes. Also, in the present embodiment, the measurement mode conversion table 3062 stores three types of measurement modes for each single type of color chart ID. That is to say, patch signal values (1) and (2) and three types of measurement modes corresponding to the patch signal values (1) and (2) are stored for each type of color verification patch.

TABLE 2

| | Patch Signal | Patch Signal | |
|---|---|---|---|
| Color | Value (1) | Value (2) | Measurement |
| Chart ID | (C, M, Y, K) | (C, M, Y, K) | Mode |
| ID 1111 | 100, 90, 0, 0 | 0, 0, 100, 0 | Normal |
| ID 1111 | 0, 100, 30, 0 | 100, 0, 50, 0 | Average |
| ID 1111 | 100, 60, 0, 0 | 0, 0, 100, 0 | Remeasurement |
| ID 2222 | 100, 50, 0, 0 | 0, 0, 80, 0 | Normal |
| ID 2222 | 0, 100, 70, 0 | 100, 0, 30, 0 | Average |
| ID 2222 | 60, 60, 0, 0 | 0, 0, 60, 0 | Remeasurement |
| . . . | . . . | . . . | . . . |

### <Application GUI>

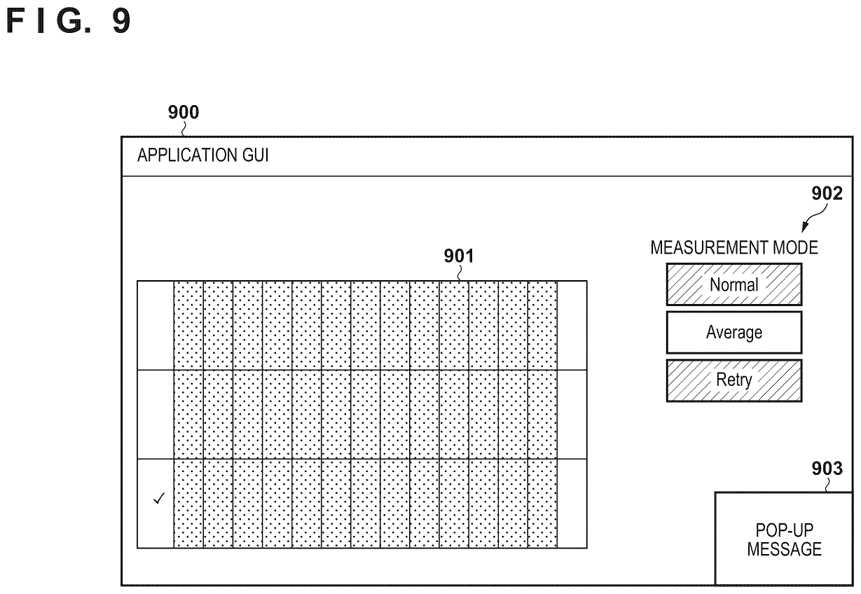

An application GUI according to the present embodiment is now described with reference to FIG. 9. FIG. 9 is a diagram showing an example of an application GUI that is displayed on the display unit 211 of the information processing apparatus 101 by the application 300 according to the present embodiment. The application GUI is a screen related to color verification.

An application GUI 900 includes a color chart colorimetry status 901, a measurement mode change interface 902, a message display unit 903, and the like. Note that as the color chart colorimetry status 901 and the message display unit 903 are similar to those of FIG. 5, a description thereof is omitted.

The measurement mode change interface 902 is an interface for changing the measurement mode. The measurement mode change interface 902 represents buttons that respectively correspond to the normal measurement mode, the average measurement mode, and the remeasurement mode. Each button is an interface capable of accepting an instruction for changing the measurement mode. Also, the application 300 may, for example, display a button pressed by the user with emphasis. For example, the application 300 may display other unpressed buttons in gray, display a button pressed by the user in a color different from colors of other unpressed buttons, or display a button pressed by the user in such a manner that it flashes. FIG. 9 shows an example in which the Average button corresponding to the average measurement mode has been pressed, and the unpressed buttons are displayed in gray.

Note that also in a case where the application 300 has received the colorimetric result of the measurement mode change patches 801a to 801c from the colorimeter 102, it may perform control so that the measurement mode change interface 902 is displayed with emphasis in accordance with the received measurement mode change patches, similarly to the case where each button has been pressed by the user. Controlling display of the measurement mode change interface 902 on the application GUI 900 allows the user to recognize the state of the current measurement mode.

### <Processing Related to Changing of Measurement Mode>

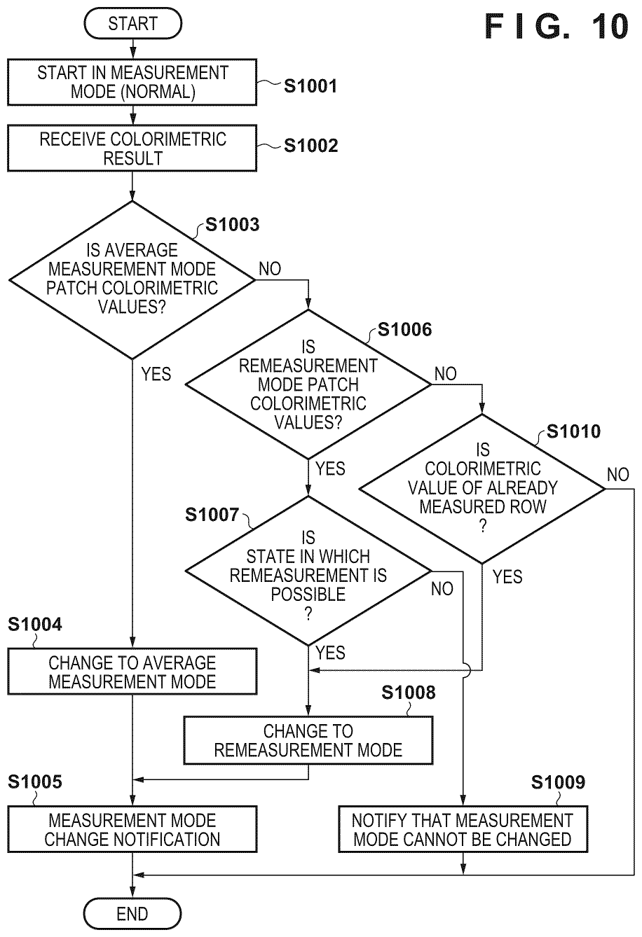

With reference to FIG. 10, a description is now given of an example of processing related to changing of the measurement mode according to the present embodiment. FIG. 10 is a flowchart showing examples of operations executed by the application 300 according to the present embodiment. Although the description will be provided under the assumption that the main executor of each type of processing in FIG. 10 is the application 300 or each program module in the application 300, processing executed by the application 300 or each program module is realized when the application 300 stored in a memory, such as the ROM 203, is deployed to the RAM 202 and executed by the CPU 201.

In step S1001, the application 300 starts the color measurement function in the state of the normal measurement mode. For example, the application 300 may transmit a color measurement instruction to the colorimeter 102 in the state of the normal measurement mode.

In step S1002, the colorimeter information reception unit 305 receives a colorimetric result from the colorimeter 102. Also, in step S1002, the colorimetric result received by the colorimeter information reception unit 305 is stored into the storage unit 301, for example.

In step S1003, the color measurement processing control unit 304 determines whether the colorimetric result received from the colorimeter 102 in step S1002 is the colorimetric values of the measurement mode change patches 801b. In a case where the color measurement processing control unit 304 has determined that the colorimetric result is the colorimetric values of the measurement mode change patches 801b in step S1003, it proceeds to step S1004. On the other hand, in a case where the color measurement processing control unit 304 has determined that the colorimetric result is not the colorimetric values of the measurement mode change patches 801b in step S1003, it proceeds to step S1006.

In step S1003, specifically, for example, the color measurement processing control unit 304 searches the measurement mode conversion table 3062 for a combination of bicolor signal values of the received measured values. Also, if the measurement mode conversion table 3062 includes a combination corresponding to the measurement mode change patches 801b, the color measurement processing control unit 304 determines that the average measurement mode patches have been measured. On the other hand, if the measurement mode conversion table 3062 does not include a combination corresponding to the measurement mode change patches 801b, it is determined that the measurement mode change patches 801b have not been measured.

In step S1004, the color measurement processing control unit 304 changes the measurement mode to the average measurement mode.

In step S1005, the GUI unit 307 provides a notification indicating that the measurement mode has been changed. Specifically, for example, the GUI unit 307 displays a message indicating that the measurement mode has been changed as the pop-up message on the message display unit 903. Also, the GUI unit 307 displays a button which is in the measurement mode change interface 902 and which corresponds to the average measurement mode with emphasis. Note that the notification indicating that the measurement mode has been changed may be provided in the form of a sound or the like.

In step S1006, the color measurement processing control unit 304 determines whether the colorimetric values received from the colorimeter information reception unit 305 are of the measurement mode change patches 801a. In a case where the colorimetric values have been determined to be of the measurement mode change patches 801a in step S1006, processing proceeds to step S1007; otherwise, processing proceeds to step S1010. Specifically, for example, the color measurement processing control unit 304 determines whether the colorimetric values are of the measurement mode change patches 801a by searching the measurement mode conversion table 3061 for a combination of bicolor signal values of the received measured values.

In step S1007, the color measurement processing control unit 304 refers to the storage unit 301, and determines whether remeasurement can be performed in the current state. In a case where the color measurement processing control unit 304 has determined that remeasurement can be performed in the current state, it proceeds to step S1008. On the other hand, in a case where the color measurement processing control unit 304 has determined that remeasurement cannot be performed in the current state, it proceeds to step S1009. The state where remeasurement can be performed is, for example, a case where the measurement result of the color verification patches 802 has already been stored in the storage unit 301 through processing of step S1002. Meanwhile, the state where remeasurement cannot be performed is, for example, a case where the colorimetric result of the color verification patches 802 has not been stored in the storage unit 301. In this case, the colorimetric result of the color verification patches 802 cannot be overwritten, and thus whether remeasurement can be performed is determined in step S1007.

In step S1008, the color measurement processing control unit 304 changes the measurement mode to the remeasurement mode.

In step S1009, the GUI unit 307 provides a notification indicating that the measurement mode cannot be changed. Specifically, the GUI unit 307 displays a warning message indicating that the measurement mode cannot be changed on the message display unit 903. Note that the notification indicating that the measurement mode cannot be changed may be provided in the form of a sound or the like with use of a speaker (not shown) or the like of the information processing apparatus 101.

In step S1010, the color measurement processing control unit 304 determines whether the colorimetric value received in step S1002 is a colorimetric value of a row that has already been measured. In a case where the color measurement processing control unit 304 has determined that the received colorimetric value is a colorimetric value of a row that has already been measured, it proceeds to step S1005. On the other hand, in a case where the color measurement processing control unit 304 has determined that the received colorimetric value is not a colorimetric value of a row that has already been measured, processing of FIG. 10 is ended.

As described above, according to the present embodiment, the color chart 800 includes a plurality of measurement mode change patches 801a to 801c. Also, the measurement mode conversion table stores a plurality of measurement modes for each color chart ID. Even in a case where there are a plurality of measurement modes, the foregoing aspect allows the user to change the measurement mode of the colorimeter 102 without switching from an operation on the colorimeter 102 to an operation on the application GUI 900 displayed on the information processing apparatus 101. This can improve convenience for a case where color measurement is performed.

### Third Embodiment

The first embodiment and the second embodiment have been described in relation to an aspect in which the application 300 changes the measurement mode in a case where it has received a colorimetric result of measurement mode change patches as a signal that is based on a user operation on the colorimeter 102. The present embodiment will be described in relation to an aspect in which the application 300 changes the measurement mode in a case where it has received a signal that is based on a predetermined operation on a button or the like of the colorimeter 102 from the colorimeter 102 as a signal that is based on a user operation on the colorimeter 102.

The present embodiment will be described under the assumption that the colorimeter 102 shown in FIG. 12 includes a user interface, such as the colorimeter button 1200. As described above, the colorimeter button 1200 is an interface capable of accepting an instruction for executing color measurement. In the present embodiment, the colorimeter button 1200 also functions as an interface capable of accepting an instruction for transmitting a signal that is based on a user operation performed on the colorimeter button 1200. For example, in a case where the user has double-clicked or long-pressed the colorimeter button 1200, the colorimeter 102 transmits a signal that is based on such a user operation to the application 300.

### <Measurement Mode Conversion Table>

Now, reference is made to table 3. Table 3 shows an example of a measurement mode conversion table included in the application 300 according to the present embodiment. In the present embodiment, a measurement mode conversion table 3063 includes a user operation (button operation) on the colorimeter 102 and a measurement mode as items. Also, the measurement mode conversion table 3063 stores signal values that are based on user operations on the colorimeter 102 in association with measurement modes corresponding to the signal values that are based on the user operations. A user operation is, for example, a button operation performed on the colorimeter button 1200, which is provided on the colorimeter 102 as stated earlier. In the present example, as shown in the measurement mode conversion table 3063, a signal value that is based on long-pressing acting as a button operation corresponds to the remeasurement mode. Also, a signal value that is based on a double-click acting as a button operation corresponds to the normal mode and the average mode.

TABLE 3

| Button Operation | Measurement Mode |
|---|---|
| {Signal Value of Double-Click} | Change Mode |
| | (Normal ↔ Average) |
| {Only Signal Value of | Remeasurement |
| Long-Pressing} | |

In the present embodiment, in a case where the colorimeter information reception unit 305 has received a signal value that is based on a button operation such as a double-click and long-pressing, the color measurement processing control unit 304 refers to the measurement mode conversion table 3063. In a case where the measurement mode conversion table 3063 stores the measurement mode corresponding to the received signal value, the color measurement processing control unit 304 controls changing of the measurement mode. For example, each time the colorimeter information reception unit 305 receives a signal value that is based on a double-click, the color measurement processing control unit 304 performs control to change the measurement mode of the application 300 between the normal mode and the average mode. That is to say, the signal value that is based on the double-click can also be said to be in correspondence with a switch mode for switching between the normal mode and the average mode.

Note that the measurement mode conversion table 3063 is not limited to the combinations of signals that are based on button operations and measurement modes corresponding to the signals that are based on the button operations shown in Table 3. For example, the measurement mode conversion table 3063 may store a signal value that is based on long-pressing acting as a button operation in association with the normal mode and the average mode, and store a signal value that is based on a double-click acting as a button operation in association with the remeasurement mode. Also, for example, it is permissible to adopt a configuration in which only a double-click switches among the three measurement modes (the normal measurement mode, the average measurement mode, and the remeasurement mode).

### <Processing Related to Changing of Measurement Mode>

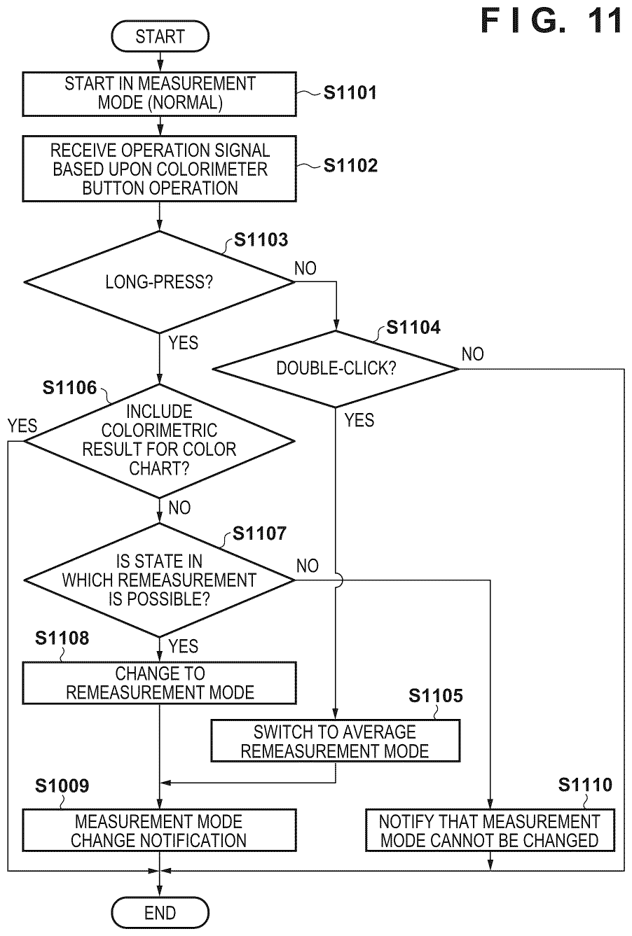

With reference to FIG. 11, a description is now given of an example of processing related to changing of the measurement mode according to the present embodiment. FIG. 11 is a flowchart showing examples of operations executed by the application 300 according to the present embodiment. Although the description will be provided under the assumption that the main executor of each type of processing in FIG. 11 is the application 300 or each program module in the application 300, processing executed by the application 300 or each program module is realized when the application 300 stored in a memory, such as the ROM 203, is deployed to the RAM 202 and executed by the CPU 201.

In step S1101, the application 300 starts the color measurement function in the state of the normal measurement mode. For example, the application 300 may transmit a color measurement instruction to the colorimeter 102 in the state of the normal measurement mode.

In step S1102, the colorimeter information reception unit 305 receives a signal value from the colorimeter 102.

In step S1103, the color measurement processing control unit 304 determines whether the signal value received by the colorimeter information reception unit 305 in step S1102 is a signal value that is based on long-pressing acting as a user operation. In a case where the color measurement processing control unit 304 has determined that the received signal value is the signal value that is based on long-pressing, it proceeds to step S1106. On the other hand, in a case where the received signal value has not been determined to be the signal value that is based on long-pressing, processing proceeds to step S1104.

In step S1103, specifically, the color measurement processing control unit 304 refers to the measurement mode conversion table 3063. Then, the color measurement processing control unit 304 determines whether the signal value received in step S1102 includes a signal value which is stored in the measurement mode conversion table 3063 and which corresponds to the remeasurement mode. In a case where the color measurement processing control unit 304 has determined that the signal value received in step S1102 includes the signal value which is stored in the measurement mode conversion table 3063 and which corresponds to the remeasurement mode, it proceeds to step S1106. On the other hand, in a case where the color measurement processing control unit 304 has determined that the signal value received in step S1102 does not include the signal value which is stored in the measurement mode conversion table 3063 and which corresponds to the remeasurement mode, it proceeds to step S1104.

Step S1104 determines whether the signal value received by the colorimeter information reception unit 305 in step S1102 is a signal value that is based on a double-click acting as a user operation. In a case where the color measurement processing control unit 304 has determined that the received signal value is the signal value that is based on the double-click, it proceeds to step S1105. On the other hand, in a case where the received signal value has not been determined to be the signal value that is based on the double-click, processing of FIG. 11 is ended.

In step S1104, specifically, the color measurement processing control unit 304 refers to the measurement mode conversion table 3063. Then, the color measurement processing control unit 304 determines whether the signal value received in step S1102 is a signal value which is stored in the measurement mode conversion table 3063 and which corresponds to a mode for switching between the normal mode and the average measurement mode. In a case where the color measurement processing control unit 304 has determined that the signal value received in step S1102 includes the signal value which is stored in the measurement mode conversion table 3063 and which corresponds to the switch mode, it proceeds to step S1105. On the other hand, in a case where the color measurement processing control unit 304 has determined that the signal value received in step S1102 does not include the signal value which is stored in the measurement mode conversion table 3063 and which corresponds to the switch mode, processing of FIG. 11 is ended.

In step S1105, the color measurement processing control unit 304 changes the measurement mode of the application 300 from the normal mode to the remeasurement mode.

In step S1106, the color measurement processing control unit 304 determines whether the signal value received in step S1102 includes a colorimetric value of a color chart (not shown). In a case where the color measurement processing control unit 304 has determined that the received signal value includes the colorimetric value of the color chart, it can be regarded that the colorimeter button 1200 has been long-pressed for color measurement of the color chart, and thus processing of FIG. 11 is ended. On the other hand, in a case where the color measurement processing control unit 304 has determined that the received signal value does not include the colorimetric value of the color chart, it can be regarded that the colorimeter button 1200 has been long-pressed to change the measurement mode, and thus processing proceeds to step S1107. That is to say, in a case where the signal value received from the colorimeter 102 in step S1102 includes only the signal value that is based on long-pressing acting as the button operation, the color measurement processing control unit 304 proceeds to step S1107.

In step S1107, the color measurement processing control unit 304 determines whether remeasurement can be performed in the current state. In a case where the color measurement processing control unit 304 has determined that remeasurement can be performed in the current state, it proceeds to step S1108. On the other hand, in a case where the color measurement processing control unit 304 has determined that remeasurement cannot be performed in the current state, it proceeds to step S1110. For example, the color measurement processing control unit 304 refers to the storage unit 301, and determines whether a colorimetric result of color verification patches has already been stored therein. In a case where the color measurement processing control unit 304 has determined that the colorimetric result of color verification patches has already been stored, it proceeds to step S1108. On the other hand, in a case where the color measurement processing control unit 304 has determined that the colorimetric result of color verification patches has not been stored, it proceeds to step S1111.

In step S1108, the color measurement processing control unit 304 changes the measurement mode of the application 300 from the normal mode to the remeasurement mode.

Processing of step S1109 is similar to processing of step S1005, and processing of step S1110 is similar to processing of step S1009; therefore, a description thereof is omitted.

As described above, according to the present embodiment, the application 300 changes the measurement mode in accordance with a signal that is based on an operation on the colorimeter button 1200. In this way, in a case where the user who performs color verification changes the measurement mode to the remeasurement mode, the user can change to the remeasurement mode merely by operating the colorimeter 102 without performing an operation on the information processing apparatus 101. This can improve convenience for a case where color verification is performed.

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-018843, filed Feb. 9, 2024, which is hereby incorporated by reference herein in its entirety.

What is claimed is:

1. A non-transitory computer-readable storage medium storing a program configured to cause a computer of an information processing apparatus to function as:
a change unit configured to, in accordance with a signal that is based on a user operation on a colorimeter, change a measurement mode related to color measurement performed by the colorimeter in color verification; and
a notification unit configured to provide a notification indicating the change in the measurement mode made by the change unit.

2. The non-transitory computer-readable storage medium storing the program according to claim 1, wherein
the computer is further caused to function as a reception unit configured to receive the signal, and
the change unit changes the measurement mode in a case where the reception unit has received a signal value for changing the measurement mode as the signal.

3. The non-transitory computer-readable storage medium storing the program according to claim 2, wherein
a color chart in the color verification includes a first patch for changing the measurement mode and a second patch for color verification, and
the change unit changes the measurement mode in a case where a colorimetric result of the color chart received by the reception unit is a first colorimetric value of the first patch.

4. The non-transitory computer-readable storage medium storing the program according to claim 3, wherein
the change unit changes the measurement mode in a case where the colorimetric result of the color chart received by the reception unit is a second colorimetric value of the second patch for color verification and the second colorimetric value is a colorimetric value that has already been measured.

5. The non-transitory computer-readable storage medium storing the program according to claim 3, wherein
the computer is further caused to function as a first storage unit configured to store a first conversion table in which a first signal value corresponding to a color of the first patch is associated with a measurement mode corresponding to the first signal value.

6. The non-transitory computer-readable storage medium storing the program according to claim 5, wherein
the computer is further caused to function as a determination unit configured to, in a case where the reception unit has received the colorimetric result, determine whether the colorimetric result is the first colorimetric value with use of the first conversion table stored in the first storage unit, and
the change unit changes the measurement mode in a case where the determination unit has determined that the colorimetric result is the first colorimetric value.

7. The non-transitory computer-readable storage medium storing the program according to claim 3, wherein
the computer is further caused to function as a generation unit configured to generate data of the color chart.

8. The non-transitory computer-readable storage medium storing the program according to claim 7, wherein
the generation unit generates the first patch using a color different from a color of the second patch.

9. The non-transitory computer-readable storage medium storing the program according to claim 7, wherein
the computer is further caused to function as an acceptance unit configured to accept information of a setting for generating the color chart, and
the generation unit generates the data of the color chart, on the basis of the information accepted by the acceptance unit.

10. The non-transitory computer-readable storage medium storing the program according to claim 7, wherein
the computer is further caused to function as a print instruction unit configured to instruct an image forming apparatus to print the color chart, on the basis of the data generated by the generation unit.

11. The non-transitory computer-readable storage medium storing the program according to claim 2, wherein
the change unit changes the measurement mode in a case where the reception unit has received an operation signal that is based on a predetermined operation performed on a user interface of the colorimeter.

12. The non-transitory computer-readable storage medium storing the program according to claim 11, wherein
the computer is further caused to function as a third storage unit configured to store a second conversion table in which a second signal value corresponding to the operation signal is associated with a measurement mode corresponding to the second signal value, and
the change unit changes the measurement mode in a case where the operation signal received by the reception unit is a signal corresponding to the second conversion table stored in the third storage unit.

13. The non-transitory computer-readable storage medium storing the program according to claim 11, wherein
the change unit changes the measurement mode in a case where the operation signal received by the reception unit does not include a measurement result of a color chart for which color measurement has been performed by the colorimeter.

14. The non-transitory computer-readable storage medium storing the program according to claim 1, wherein
the measurement mode includes a first mode that performs color verification with respect to a colorimetric value of a color chart obtained through a single session of color measurement performed by the colorimeter,
a second mode that performs color verification with respect to a colorimetric value of the color chart obtained through remeasurement of colors performed by the colorimeter, and
a third mode that performs color verification with respect to an average value of colorimetric values of the color chart obtained through a plurality of sessions of color measurement performed by the colorimeter.

15. The non-transitory computer-readable storage medium storing the program according to claim 1, wherein
the computer is further caused to function as a display unit configured to display the notification by the notification unit.

16. A method executed by an information processing apparatus, the method comprising:
in accordance with a signal that is based on a user operation on a colorimeter, changing a measurement mode related to measurement performed by the colorimeter in color verification; and
providing a notification indicating the change in the measurement mode made by the changing.
